(19) United States
(12) Patent Application Publication
(10) Pub. No.: US 2010/0176197 A1
(43) Pub. Date: Jul. 15, 2010

(54) BILL ACCEPTOR HAVING A RFID RECOGNITION FUNCTION

(75) Inventors: Ruei-Jia HUANG, Taipei City (TW); Tien-Yuan CHIEN, Taipei City (TW)

Correspondence Address: Muncy, Geissler, Olds & Lowe, PLLC, 4000 Legato Road, Suite 310, FAIRFAX, VA, 22033, US

(73) Assignee: INTERNATIONAL CURRENCY TECHNOLOGIES CORPORATION, Taipei (TW)

(21) Appl. No.: 12/719,556

(22) Filed: Mar. 8, 2010

Related U.S. Application Data
(63) Continuation-in-part of application No. 12/039,745, filed on Feb. 29, 2008.

(51) Int. Cl. G07F 7/08; G06F 17/00

(52) U.S. Cl. 235/381

(57) ABSTRACT

A bill acceptor for use in an automatic vending machine to accept both cash payment and RFID stored-value card payment is disclosed to include a face panel that has a RFID sensing zone for sensing a RFID value-added card, a bill insertion slot for the insertion of a bill, a display for displaying data and operating buttons for operation by the user, and a bill acceptor body that has a bill passage connected to the bill insertion slot, a bill-transfer roller set for transferring an inserted bill from the bill insertion slot through the bill passage to a bill box and a control circuit module consisting of a microprocessor, a RFID chip, a sensor, a memory, a surveillance device and a clock.

This application is a Continuation-In-Part of my patent application Ser. No. 12/039,745, filed on Feb. 29, 2008.

### BACKGROUND OF THE INVENTION

1. Field of the Invention

The present invention relates to bill acceptors and more particularly, to a bill acceptor having a RFID recognition function radio frequency identification used in an automatic vending machine that has installed in the face panel thereof sensor means for sensing a RFID stored-value card and a bill insertion slot for the insertion of a bill so that the automatic vending machine accepts both cash payment and RFID stored-value card payment.

2. Description of the Related Art

Following fast development of technology, the distance among people has been greatly shortened, our mode of living has been changed, and everything requires efficiency, time saving and quickness. In consequence, different automatic vending machines are used everywhere to sell different products without serviceman. These automatic vending machines are highly invited for the advantage of saving much labor and bringing convenience to people. Nowadays, Q-shops are seen in many places to provide different services to consumers. A Q-shop has the advantages of scientific intelligence, quick service, and quick finish of payment. A Q-shop may provide different automatic vending machines for vending drinks, cigarettes, tickets, ice creams, tickets, memorial coins, key rings, or even hamburgers and noodles. Further, many virtual shops are established to make online shopping, allowing shoppers to shop across millions of products.

Due to the aforesaid automatic vending machine's numerous advantages, a distributor may widely install automatic vending machines in urban and rural areas to make more profit and to save costs. An automatic vending machine may be equipped with a bill acceptor to accept cash payment. When a consumer inserted a bill into the bill insertion slot of the bill acceptor of an automatic vending machine, the bill acceptor recognizes the authenticity of the inserted bill, and then the automatic vending machine allows the transaction to be run after acceptance of the inserted bill.

However, paper money will become dirty and wrinkled soon after having been put into the market. In order to eliminate the drawbacks of cash transaction, plastic money is created. A consumer can add money to a value-added card through a value-added machine. By means of using a value-added card or credit card instead of real money, a consumer needs not to carry a big amount of paper money when goes shopping. Further, following fast development of RFID (Radio Frequency Identification) technology, RFID stored-value cards have been intensively used in many places to substitute for conventional paper cards and contact type magnetic cards for different transactions. When a RFID stored-value card is used, the user needs not to take the RFID stored-value card out of the pocket or purse, and the stored value on the RFID stored-value card can be read by a RFID reader at a distance. Therefore, RFID stored-value cards are widely invited by consumers.

In order to add a RFID reader to an automatic vending machine to satisfy certain consumers' spending habit, an extra space in the automatic vending machine must be provided, and the internal circuit module of the automatic vending machine must be modified. To a business owner, it is difficult to change update all their automatic vending machines that are installed in different places. It takes much time and labor to take back all the installed automatic vending machines for modification, increasing much the cost.

Further, adding a new device to the inside of an automatic vending machine requires an installation space in the automatic vending machine. The internal space arrangement of an automatic vending machine is quite different from that of an auto teller machine (ATM). An auto teller machine has sufficient internal space for the installation of a RFID reader. Further, an auto teller machine already has a contact card reader installed therein. Upgrading an auto teller machine to the non-contact card reading operation is quite simple. After removal of the contact card reader from the auto teller machine, a non-contact card reader can be directly installed in the auto teller machine at the location originally provided for the removed contact card reader without changing the structure of the housing of the auto teller machine.

Conventional automatic vending machines simply use a bill acceptor to accept cash payment. The internal space of an automatic vending machine has a standard specification. When adding a new device to the inside of a conventional automatic vending machine, the arrangement of the internal components of the automatic vending machine must be changed, wasting much time and labor.

Therefore, it is desirable to provide a bill acceptor for automatic vending machine that solves the aforesaid problems.

### SUMMARY OF THE INVENTION

The present invention has been accomplished under the circumstances in view. It is therefore the main object of the present invention to provide a bill acceptor for use in an automatic vending machine, which accepts a bill as well as a RFID stored-value cad for transaction, and is operable to add value to a RFID stored-value card. It is another object of the present invention, which integrates a bill recognition device and a RFID recognition device, saving much the manufacturing cost and the installation space.

To achieve these and other objects of the present invention, a bill acceptor comprises a bill acceptor body and a face panel. The face panel has arranged on the front surface thereof a RFID sensing zone for sensing a RFID value-added card, a bill insertion slot for the insertion of a bill, and a display for displaying data. The bill acceptor body is mounted on the back side of the face panel, having a bill passage connected to the bill insertion slot, a bill-transfer roller set for transferring an inserted bill from the bill insertion slot through the bill passage and a control circuit module for reading and writing a RFID value-added card. When the bill acceptor is used in an automatic vending machine, the automatic vending machine accepts both paper money and RFID value-added card for transaction.

Further, the bill acceptor can be used in a conventional automatic vending machine to replace the original bill acceptor of the automatic vending machine, so that the automatic vending machine can accept both paper money and RFID value-added card for transaction without making any change of the internal arrangement.

Because the bill acceptor has a RFID sensing zone and a bill insertion slot provided at the face panel and a control circuit module mounted in the bill acceptor body, an automatic vending machine using the bill acceptor can accept both cash payment and RFID stored-value card payment, and a user can use the machine to add a value to a RFID value-added card. By means of incorporating a bill acceptor and a RFID reader/writer into one single unit, the invention saves much the installation space and the manufacturing cost.

### BRIEF DESCRIPTION OF THE DRAWINGS

FIG. 1 is an elevational view of a bill acceptor in accordance with the present invention.

FIG. 2 is a sectional side view of the bill acceptor in accordance with the present invention.

FIG. 3 circuit block diagram of the present invention.

FIG. 4 is an operation flow chart of the bill acceptor in accordance with the present invention (I).

FIG. 5 is an operation flow chart of the bill acceptor in accordance with the present invention (II).

FIG. 6 is an operation flow chart of an automatic vending machine equipped with a bill acceptor in accordance with the present invention (I).

FIG. 7 is an operation flow chart of an automatic vending machine equipped with a bill acceptor in accordance with the present invention (II).

FIG. 8 is an elevational view of an alternate form of the face panel of the bill acceptor according to the present invention.

FIG. 9 is an elevational view of another alternate form of the face panel of the bill acceptor according to the present invention.

### DETAILED DESCRIPTION OF THE PREFERRED EMBODIMENT

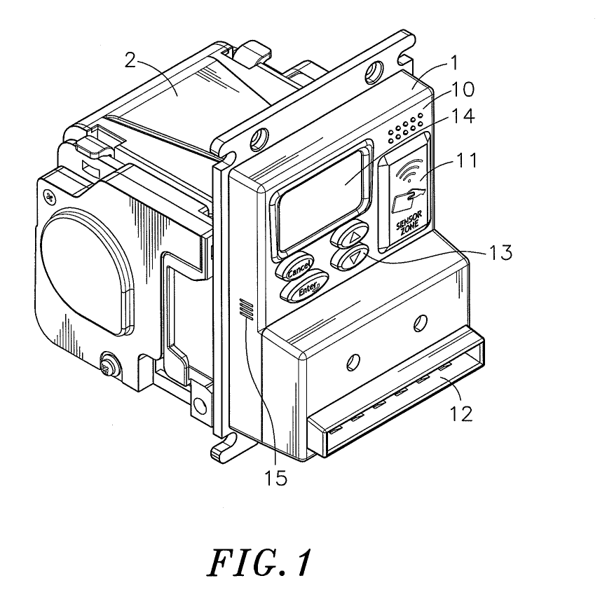

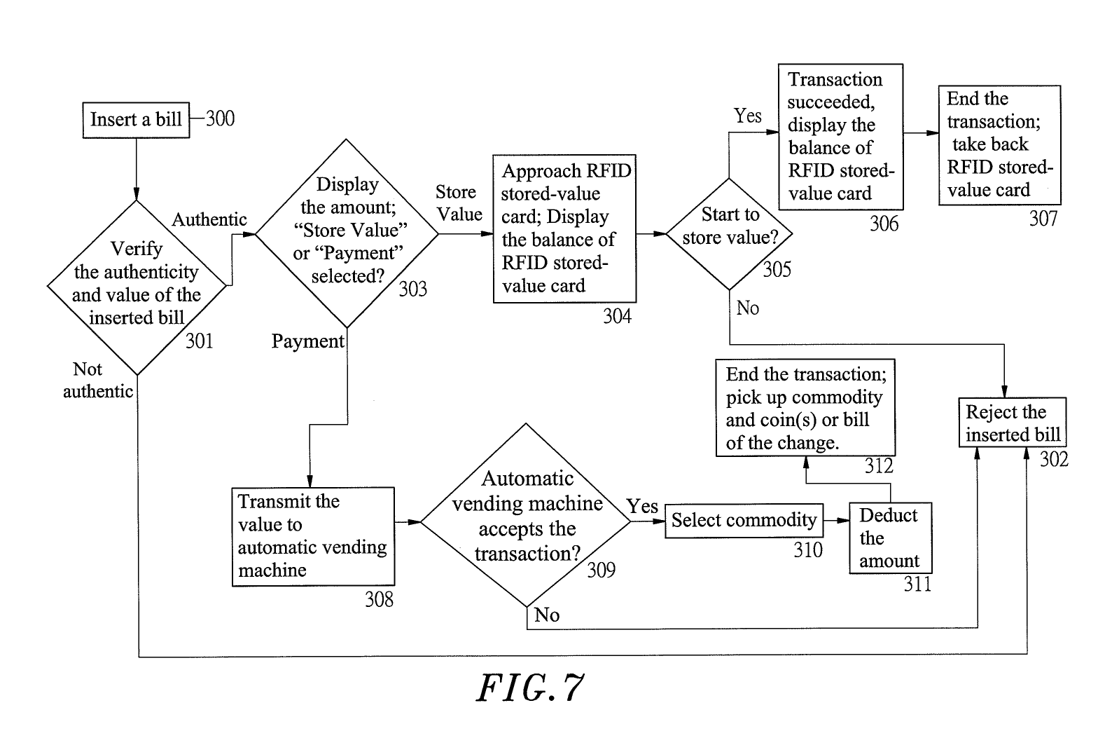

Referring to FIGS. 1 and 7, a bill acceptor having a RFID (radio frequency recognition) function in accordance with the present invention is shown comprising a face panel 1, a bill acceptor body 2, and a control circuit module 3.

The face panel 1 has a RFID sensing zone 11 and a bill insertion slot 12 on the front surface 10 thereof, a passage 121 backwardly extended from the bill insertion slot 12, an operating button set 13 for operation by a user, and a display 14 for displaying data. The operating button set 13 can be a set of mechanical buttons, or a set of touch buttons on the display 14.

The bill acceptor body 2 is mounted on the back side of the face panel 1 opposite to the front surface 10, having a bill passage 21 in communication with the passage 121 of the face panel 1 for receiving an inserted bill from the bill insertion slot 12, a bill-transfer roller set 22 for carrying the inserted bill through the bill passage 21 toward an internal bill box (not shown), a recognition device 23 disposed adjacent to the bill passage 21 and controllable to recognition the authenticity and value of the inserted bill, and an anti-theft mechanism 24 set behind the recognition device 23.

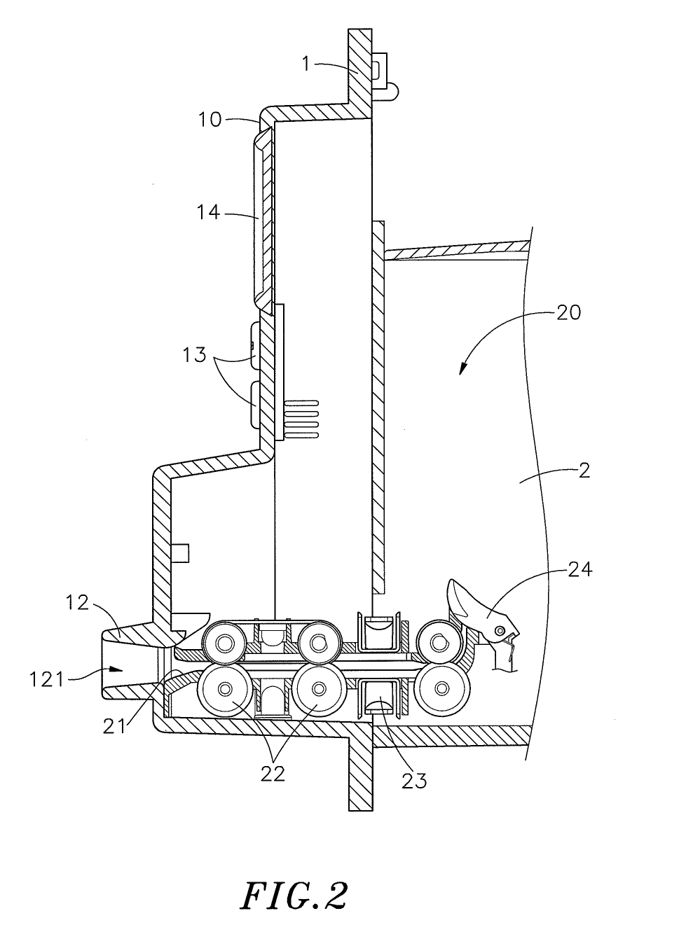

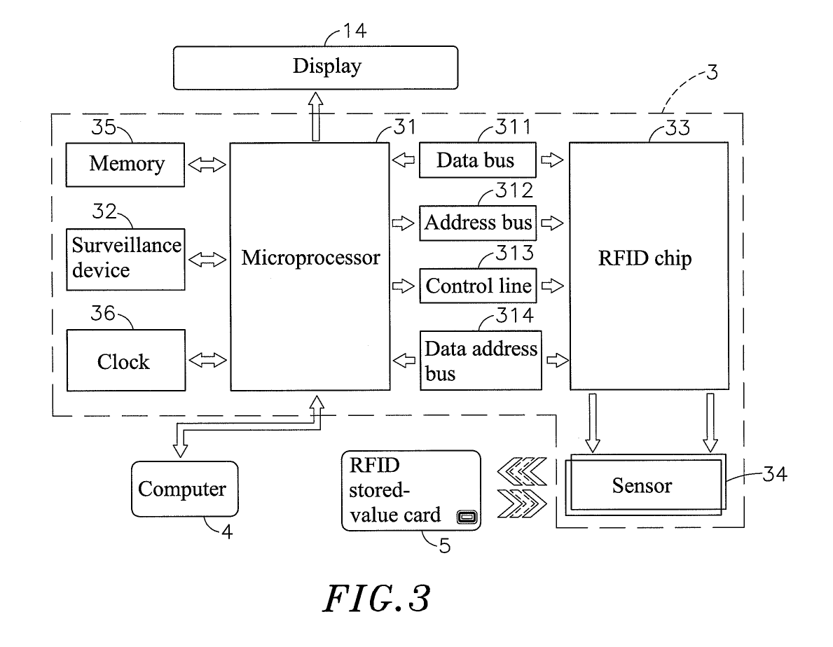

Referring to FIG. 3 and FIG. 2 again, the control circuit module 3 is installed in an installation space 20 in between the face panel 1 and the bill acceptor body 2 (alternatively, the control circuit module 3 can be installed in the face panel 1). The control circuit module 3 comprises a microprocessor 31 for data processing, a surveillance device 32, a RFID chip 33, a sensor 34, a memory 35 for storing data, and a clock 36. The microprocessor 31 has connected thereto a data bus 311, an address bus 312, a control line 313, and a data address bus 314. By means of the data bus 311, the address bus 312, the control line 313 and the data address bus 314, the microprocessor is electrically connected with the RFID chip 33 for communication with a RFID stored-value card 5. The sensor 34 is controlled by the RFID chip 33 to sense a RFID stored-value card 5. Further, the memory 35 and the clock 36 are respectively electrically connected to the microprocessor 31.

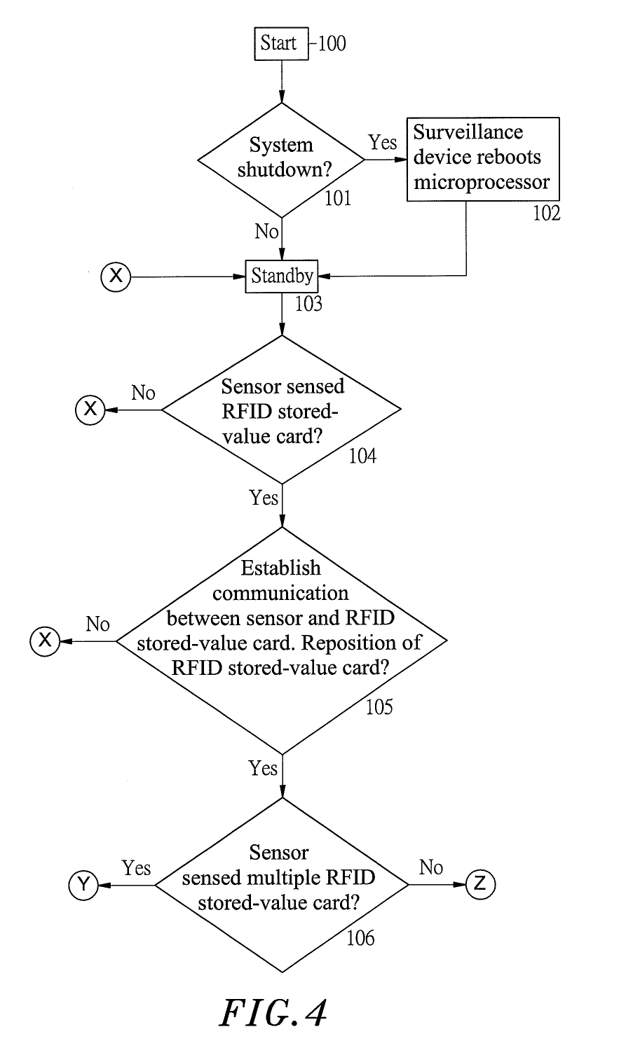

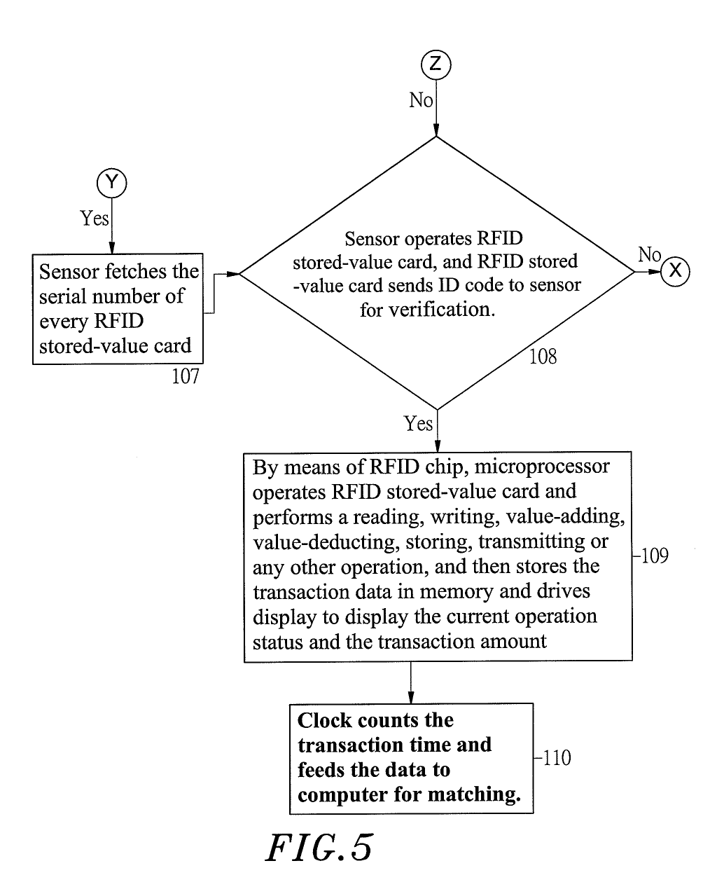

Referring to FIGS. 4 and 5 and FIG. 3 again, during operation of the present invention, the control circuit module 3 runs subject to the following steps:
100 Start
101 System shutdown? And then proceed to step 102 when system is shut down, or step 103 when not.
102 Surveillance device 32 drives microprocessor 31 to start again.
103 Standby.
104 Sensor 34 sensed a RFID stored-value card 5? And then proceed to step 105 when positive, or return to step 103 through X when negative.
105 Establish communication between sensor 34 and RFID stored-value card 5. RFID stored-value card 5 repositioned? And then proceed to step 106 when yes, or step 103 through X when not.
106 Sensor 34 sensed multiple RFID stored-value card 5? And then proceed to step 107 through Y when yes, or step 108 through Z when not.
107 Sensor 34 fetches the serial number of every RFID stored-value card 5, and senses only one RFID stored-value card 5 at a time. And then proceed to step 108.
108 Sensor 34 operates RFID stored-value card 5 so that RFID stored-value card 5 sends its ID code to sensor 34 for authenticity verification. Proceed to step 109 when the ID code of RFID stored-value card 5 is recognized to be correct, or step 103 through X when the code is incorrect.
109 Microprocessor 31 operates RFID stored-value card 5 via RFID chip 33, performing a reading, writing, value-adding, value-deducting, storing, transmitting or any other operation, and then stores the transaction data in memory 35 and drives display 14 to display the current operation status and the transaction amount.
110 Clock 36 counts the time being consumed and feeds the data to external computer 4 for matching.

As stated above, when the microprocessor 31 of the control circuit module 3 controls the RFID chip 33 to communicate with a RFID stored-value card 5 by means of the sensor 34, the sensor 34 gives the command of “Request std” to the RFID stored-value card 5, and the RFID stored-value card 5 sends its tagtype to the sensor 34 to establish communication after initialization of the function of “Answer to Request (ATR)”. At this time, the sensor 34 reads in the serial number, size byte of the RFID stored-value card 5, and checks the correctness of the code. When the code is verified, the sensor 34 operates the RFID stored-value card 5 subject to selection.

By means of RFID chip 33, the microprocessor 31 operates the RFID stored-value card 5 to perform a reading, writing, value-adding, value-deducting, storing, transmitting or any other operation. As stated above, the microprocessor 31 is electrically connected with the RFID chip 33 by means of the data bus 311, the address bus 312, the control line 313, and the data address bus 314 so that data, address and control signal transmission can be performed between the microprocessor 31 and the sensor 33. Further, because the memory 35 is electrically connected to the microprocessor 31, the microprocessor 31 can store the data of every transaction in the memory 35. Further, the microprocessor 31 has the clock 36 electrically connected thereto. When a transaction is started, the microprocessor 31 uses the clock 36 to count the transaction time and transmits the transaction start time to the computer 4 for counting. If the transaction surpassed a predetermined length of time, the computer 4 starts to run a related process, such as canceling the transaction, establishing communication with the RFID stored-value card 5 again, returning the bill, or other process. Upon the end of the transaction, the microprocessor 31 sends the end time of the transaction to the computer 4, enabling the computer 4 to record or store the transaction time.

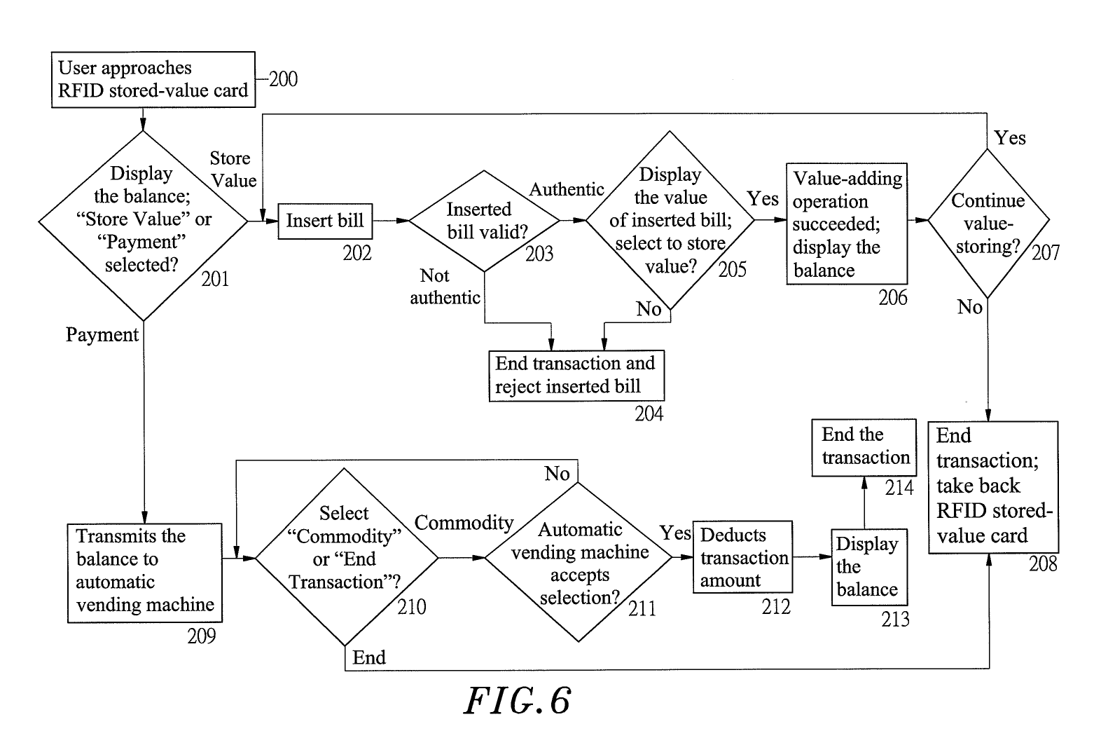

Referring to FIG. 6 and FIG. 3 again, when a consumer uses a RFID stored-value card 5 for operation, it runs subject to the following steps:
200 User approaches RFID stored-value card 5.
201 System displays the balance of approached stored-value card 5; User selects “Store Value” or “Payment”, and then system proceeds to step 202 when “Store Value” is selected, or step 209 when “Payment” is selected.
202 User inserts a bill, and then system proceeds to step 203.
203 System checks the authenticity of the inserted bill, and then proceeds to step 204 if the inserted bill is invalid, or step 205 if the inserted bill is valid.
204 System ends the transaction and rejects the inserted bill.
205 System displays the value of the inserted bill, and then determines whether or not user selects to store value, and then returns to step 204 when negative, or proceeds to step 206 when positive.
206 System stores the corresponding value and displays the balance, and then proceeds to step 207.
207 System determines whether or not user selects to continue storing value? And then, system returns to step 202 when user selects to continue storing value, or proceeds to step 208 when not.
208 System ends the transaction, and user takes back RFID stored-value card.
209 System transmits the data of the balance to the automatic vending machine.
210 User selects “Commodity” or “End Transaction”. System returns to step 208 when “End Transaction” is selected, or proceeds to step 211 when “Commodity” is selected.
211 System determines whether or not the automatic vending machine accepts the selection, and then proceeds to step 212 when positive, or returns to step 210 when negative.
212 System deducts the transaction amount from RFID stored-value card and then proceeds to step 213.
213 System displays the balance.
214 The transaction is ended; user picks up the commodity; system returns to step 208.

Referring to FIG. 7 and FIG. 3 again, when a consumer uses a bill for transaction, the system runs subject to the following steps:
300 User inserts a bill.
301 System checks the authenticity and value of the inserted bill, and then proceeds to step 302 if the inserted bill is valid, or step 303 if the inserted bill is invalid.
302 System rejects the inserted bill.
303 System displays the amount of the value of the inserted bill; user selects “Store Value” or “Payment”; system proceeds to step 304 when “Store Value” is selected, or step 308 when “Payment” is selected.
304 User inserts the card; system displays the balance of the inserted card and then proceeds to step 305.
305 System determines whether or not user selects to store value? And then system returns to step 302 if user selects to store value, or proceeds to step 306 if not.
306 Transaction succeeded; system displays the balance of the card and then proceeds to step 307.
307 Transaction is ended; user takes back the card.
308 System transmits the value of the inserted bill to automatic vending machine.
309 System determines whether or not automatic vending machine accepts the value, and then returns to step 302 when automatic vending machine rejects the value, or proceeds to step 310 when automatic vending machine accepts the value.
310 User selects commodity.
311 System deducts the transaction amount.
312 System ends the transaction; user picks up the commodity and the coin(s) or bill of the change.

Referring to FIGS. 6 and 7 and FIGS. 1-3 again, when a user uses a RFID stored-value card 5 for transaction, the user can approach the RFID stored-value card 5 to the RFID sensing zone 11 of the face panel 1. At this time, the microprocessor 31 of the control circuit module 3 drives the RFID chip 33 and the sensor 34 to establish communication with the RFID stored-value card 5 and to verify the identification of the RFID stored-value card 5. When the identification of the RFID stored-value card 5 is identified, the microprocessor 31 drives the display 34 to display the value stored in the RFID stored-value card 5. At this time, the user operates the operating buttons 13 at the face panel 1 to select the desired operating mode. When “Store Value” is selected, the user can then insert the bill through the bill insertion slot 12 of the face panel 1 into the passages 121 and 21. At this time, the bill-transfer roller set 22 is driven to carry the inserted bill forwards, and the recognition device 23 is controlled to recognize the authenticity and value of the inserted bill. After recognition of the authenticity and value of the inserted bill, the microprocessor 31 of the control circuit module 3 drives the RFID chip 33 and the sensor 34 to write the stored value into the RFID stored-value card 5. When “Payment” is selected, the microprocessor 31 transmits the amount of the currently available stored value of the RFID stored-value card 5 to the automatic vending machine, and the automatic vending machine sends back the transaction amount to the microprocessor 31 after the transaction is done. Thereafter, the microprocessor 31 displays the rest of the stored value on the display 34, and drives the RFID chip 33 and the sensor 34 to deduct the transaction amount from the RFID stored-value card 5. If the user selects to end the transaction, the microprocessor 31 displays the message on the display 34 so that the user can take back the RFID stored-value card 5. When using paper money, the user can select “Store Value” or “Payment”. If “Store Value”, the aforesaid value storing operation is performed. If “Payment” is selected, the system transmits the value of the inserted bill to the automatic vending machine, and then runs commodity selection and amount deduction after the automatic vending machine accepts the value. After the transaction is done, the user picks up the commodity and the coins or bill of the change.

When a bill entered the bill passage 21, the bill-transfer roller set 22 carries the bill forwards, and the recognition device 23 recognizes the text, graphics and/or other anti-counterfeit characteristics of the bill, thereby checking the authenticity and value of the bill. After recognition of the authenticity and value of the bill, the bill is received in the bill box in the automatic vending machine, and the related transaction procedure is performed. Further, the anti-theft mechanism 24 that is set behind the recognition device 23 prohibits an evil person to pull back the inserted bill after the recognition procedure. The related bill transfer, bill recognition, bill storage and anti-theft procedures are of the known techniques, and therefore no further detailed description in this regard is necessary.

Referring to FIGS. 1˜3 again, the face panel 1 is provided at one side of the bill acceptor body 2, having the aforesaid RFID sensing zone 11 and bill insertion slot 12 disposed at its front side. The aforesaid control circuit module 3 is mounted inside the bill acceptor body 2. Thus, the face panel 1 can access to the value stored in the approached RFID stored-value card 5, and the user can insert a bill into the face panel 1 to store a value to the approached RFID stored-value card 5. Unlike conventional discrete designs, the invention has a RFID reader and a bill acceptor be incorporated into a single unit, saving much the installation space. Thus, an automatic vending machine equipped with a bill acceptor having a RFID function according to the present invention has the characteristic of space-saving, and is practical for use in a railway/subway/bus station or shop.

Further, when a bill acceptor made according to the present invention is installed in an automatic vending machine, the automatic vending machine becomes able to accept both cash payment and RFID stored-value card payment. When a RFID stored-value card 5 is approached to the face panel of the bill acceptor of the automatic vending machine and recognized to be a valid card, the value stored in the RFID stored-value card 5 can be used for a transaction, and the user can insert a bill into the automatic vending machine to add a value to the RFID stored-value card 5 and then to make a transaction. Further, a user can directly insert a bill into the automatic vending machine for a transaction.

Regular automatic vending machines commonly have a big size so that the internal space can be used to store commodities. After accommodation of a big number of commodities in an automatic vending machine, no much internal space is left for utilization. If to install an extra device in the internal space of an automatic vending machine, the internal arrangement of the automatic vending machine must be changed. If a business owner is planning to upgrade all the installed automatic vending machines, it will take much time and labor and the related cost will be very high, i.e., the business owner must send people to take back all the installed automatic vending machines and then to make a hole on each retrieved automatic vending machine or to modify the internal design of each retrieved automatic vending machine for the installation of a RFID reader. The invention has a paper money payment function and a RFID value-added card payment function be incorporated into one single bill acceptor. Thus, a bill acceptor of the present invention can be used in a conventional automatic vending machine to replace the original bill acceptor of the automatic vending machine directly without changing the internal arrangement of the automatic vending machine. After installation of the bill acceptor of the present invention, the dimension of the automatic vending machine remains unchanged, and the automatic vending machine becomes able to accept both cash payment and RFID stored-value card payment and allows a user to add value to a RFID value-added card.

Therefore, installing a bill acceptor of the present invention in a conventional automatic vending machine enables the automatic vending machine to provide an extra function for RFID transaction without increasing the dimension of the automatic vending machine.

Further, a source generator 15 may be installed in the face panel 1 (see FIG. 1). When a user operates the face panel 1, the sound generator 15 gives a corresponding sound. The sound can be a warning sound, predetermined speech or background music, rendering a comfort and convenient operating environment.

Instead of the aforesaid operating buttons 13 and display 14, the face panel 1 can be provided with a touch screen for use as a display screen as well as an input device.

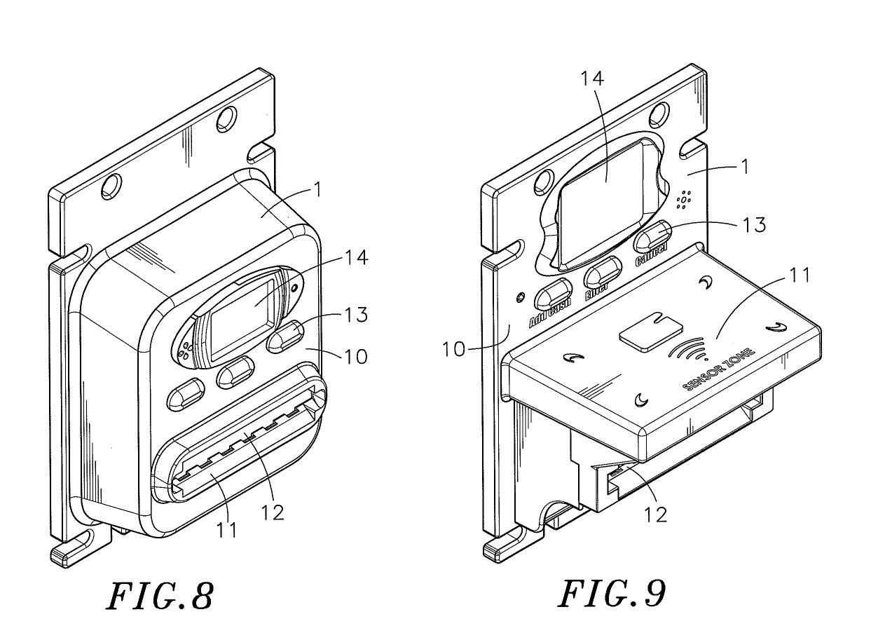

Referring to FIG. 1 again, the RFID sensing zone 11 is a vertical plane provided at the front side of the face panel 1 in a perpendicular manner relative to the bill insertion slot 12 and disposed at one lateral side relative to the display 14 and the operating buttons 13. FIG. 8 shows an alternate form of the face panel 1 in which the RFID sensing zone 11 is horizontally located on the front side inside the bill insertion slot 12. FIG. 9 shows another alternate form of the face panel 1 in which the RFID sensing zone 11 is a platform perpendicularly forwardly extended from the front wall thereof below the elevation of the operating buttons 13.

As stated above, the invention provides a bill acceptor having a RFID recognition function, which has the following features and advantages:

1. The face panel 1 has arranged on the front surface 10 thereof a RFID sensing zone 11 for sensing a RFID stored-value card 5 and a bill insertion slot 12 for the insertion of a bill, and a passage 121 backwardly extended from the bill insertion slot 12; the bill acceptor body 2 is fixedly mounted on the back side of the face panel 1 opposite to the front surface 10, having a bill passage 21 connected to the passage 121 of the face panel 1 and a bill-transfer roller set 22 for transferring the inserted bill through the bill passage 21 toward a bill box in an automatic vending machine in which the bill acceptor is used. Thus, using a bill acceptor of the present invention in an automatic vending machine enables the automatic vending machine to accept both cash payment and RFID stored-value card payment and needs not to modify the internal arrangement of the automatic vending machine.

2. The bill acceptor has a RFID sensing zone 11 and a bill insertion slot 12 provided at the face panel 1 and a control circuit module 3 mounted in the bill acceptor body 2. When the bill acceptor is used in an automatic vending machine, the automatic vending machine becomes able to accept both cash payment and RFID stored-value card payment, and a user can use the machine to add a value to a RFID value-added card 5. By means of incorporating a bill acceptor and a RFID reader/writer into one single unit, the invention saves much the installation space.

3. The bill acceptor has a RFID sensing zone 11 provided at the face panel 1 and a control circuit module 3 mounted in the bill acceptor body 2 for providing an additional RFID recognition function, i.e., the invention has a bill acceptor and a RFID reader/writer be integrated, saving the cost.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A bill acceptor comprising a bill acceptor body and a face panel and used in an automatic vending machine, wherein said face panel has arranged on a front surface thereof a RFID sensing zone for sensing a RFID value-added card and a bill insertion slot for the insertion of a bill, a set of operating buttons for operation by a user and a display adapted for displaying data; said bill acceptor body is mounted on a back side of said face panel opposite to said front surface, having a bill passage connected to said bill insertion slot and a bill-transfer roller set installed therein and adapted for transferring an inserted bill from said bill insertion slot through said bill passage.

2. The bill acceptor as claimed in claim 1, wherein said face panel further comprises a sound generator adapted for producing sound to indicate the operating status of the bill acceptor.

3. The bill acceptor as claimed in claim 1, wherein said bill acceptor body comprises a control circuit module, said control circuit module comprising a microprocessor for processing data, a RFID (radio frequency identification) chip electrically connected to said microprocessor and controlled by said microprocessor to operate a RFID stored-value card and to perform reading, writing, value-adding, value-deducting, value-storing, value-transferring operations with the RFID stored-value card, and a sensor electrically connected to said microprocessor and controlled by said microprocessor to establish communication with the sensed RFID stored-value card for signal transmission, and a memory electrically connected to said microprocessor and controlled by said microprocessor to store data.

4. The bill acceptor as claimed in claim 3, wherein said control circuit module further comprises a surveillance device adapted to reboost said microprocessor when the system is shut down.

5. The bill acceptor as claimed in claim 4, wherein said control circuit module further comprises a clock electrically connected to said microprocessor and adapted for counting the transaction time of a transaction and sending the counted transaction time to said microprocessor.

6. The bill acceptor as claimed in claim 5, wherein said microprocessor of said control circuit module is electrically connected to an external computer adapted for accessing transaction data and time of a transaction and matching the transaction time of the transaction with a predetermined reference time.

7. The bill acceptor as claimed in claim 1, wherein said bill acceptor body is installed in the automatic vending machine.

8. The bill acceptor as claimed in claim 1, wherein said RFID sensing zone is arranged above said bill insertion slot.

9. The bill acceptor as claimed in claim 1, wherein said operating buttons and said RFID sensing zone are provided between said display and said bill insertion slot.

10. The bill acceptor as claimed in claim 1, wherein said operating buttons are arranged above said display.

11. The bill acceptor as claimed in claim 1, wherein said RFID sensing zone has the shape of a platform perpendicularly forwardly extended from said front surface of said face panel in a parallel manner relative to said bill insertion slot.

12. The bill acceptor as claimed in claim 11, wherein said bill insertion slot is located on the right-angle corner between said RFID sensing zone and said front surface of said face panel, having two sidewalls connected between said front surface sand said RFID sensing zone.

13. The bill acceptor as claimed in claim 1, wherein said RFID sensing zone is located on said front surface of said face panel and extends perpendicular to said bill insertion slot.

14. The bill acceptor as claimed in claim 11, wherein said bill acceptor body further has a recognition device installed therein adjacent to said bill passage and adapted for recognizing the authenticity and value of an inserted bill.

15. The bill acceptor as claimed in claim 14, wherein said bill acceptor body further has an anti-theft mechanism set therein behind said recognition device.

16. The bill acceptor as claimed in claim 1, wherein said operating buttons are mechanical buttons.

17. The bill acceptor as claimed in claim 1, wherein said operating buttons are touch control buttons on said display.
